(19) United States
(12) Patent Application Publication
(10) Pub. No.: US 2017/0030389 A1
(43) Pub. Date: Feb. 2, 2017

(54) Clamping Snap-In Fastener

(71) Applicant: Penn Engineering & Manufacturing Corp., Danboro, PA (US)

(72) Inventor: Jacques Abboud, Pipersville, PA (US)

(21) Appl. No.: 15/198,112

(22) Filed: Jun. 30, 2016

Related U.S. Application Data
(60) Provisional application No. 62/187,209, filed on Jun. 30, 2015.

(51) Int. Cl. F16B 5/06; F16B 2/22

(52) U.S. Cl. CPC F16B 5/0642; F16B 2/22

(57) ABSTRACT

A clamping snap-in fastener has a head with laterally-projecting, resilient arms that are curved and tapered toward their extremities. The arms are angled downwardly. Two resilient legs extend downwardly from the head. Each leg has a foot with a barb, an outwardly-projecting heel at the distal free end, and an undercut between the heel and the barb. The barb has a planar top surface that extends substantially perpendicular to the lengthwise axis of the leg, and a planar lower surface that extends inwardly from the upper surface toward the heel. The undercut lies between the lower surface and the heel at the bottom end of each leg. The fastener may be used to assemble two or more panels face-to-face through aligned apertures in the panels. After assembly, the panels are attached between the fastener head and the barbs with a residual clamp load applied by the deflection and resilience of the arms of the head.

### RELATED APPLICATIONS

This application is a non-provisional patent application of U.S. provisional patent application No. 62/187,209, entitled “Snap-In Fastener”, filed Jun. 30, 2015, priority from which is hereby claimed.

### FIELD OF THE INVENTION

The present invention relates to snap-in fasteners having particular use for connecting micro-assemblies.

### BACKGROUND OF THE INVENTION

There are many known snap-in fasteners that include an elastically-deformable pin to join two panels together. Such fasteners have a variety of different shapes and are made of a variety of different resilient materials. Jacobs, U.S. Pat. No. 4,973,212, discloses a snap-in fastener of this type. Jacob's fastener includes a head and a deformable lead pin that is fixed at its base to the head and extends distally to its tip. The pin has a lengthwise bifurcation that defines deformable legs 16, 18. The diameter of the deformable lead pin is tapered from a minimum at the distal tip, which is much smaller than the diameter of the panel hole, to a maximum at an intermediate point 20a, 20b, which is larger in its relaxed condition than the diameter of the panel hole. The intermediate point 20a, 20b and the pin base define the boundaries of the pin “seat”, i.e., the critical section of the pin that impinges (after installation) on the underside of the lower panel to secure the components together. As the pin enters the holes of stacked panels 24 and 32, the legs 16 and 18 contact the lower panel 24 and are compressed inwardly. When the underside of the head 26 bottoms out against the top surface of the upper panel 32, the resilience of the legs 16, 18 and the reverse taper of the seat impinging on the underside of the lower panel provide a residual clamping force between the panels.

Snap-in fasteners such as disclosed by Jacobs are useful for joining many sizes of panels but not micro-assembly panels, for example, panels having a combined thickness of about 0.6 mm. For such applications, the tapered lead pin of prior art fasteners is inefficient and insufficient. A single lead taper such as shown in the Jacobs patent is unstable in micro-assemblies because during initial positioning there are only two lateral points of contact with the second panel, which does not prevent the fastener from tipping out of proper alignment during installation. When considering a single lead taper, numerical simulations using finite element analysis (FEA) techniques in addition to experimental investigations demonstrate that the part tends to tip left or right during the installation phase, thereby preventing a successful assembly. Since there is currently no known solution to this problem, it would be desirable to provide a clean, simple and rigid snap-in fastener for the micro-assembling industry that also will not tip out of alignment during installation. It would also be desirable to provide a panel-to-panel micro assembly with fasteners that provides a simple solution to the problems posed by prior art fasteners described above.

### SUMMARY OF THE INVENTION

The snap-in fastener in accordance with preferred embodiments of the invention satisfies the above-described need in the art of micro-assembly fasteners. The snap-in fastener assembles two panels together without any modification of their initial properties and characteristics, i.e. of their condition before assembly. The snap-in fastener may be used to connect panels of different materials and thicknesses.

In one preferred embodiment, the novel snap-in fastener of the present invention generally comprises a rectangular, generally-planar head having laterally-projecting resilient arms, each of which is fixed at its base to opposed sides of the head. The arms are angled downwardly, i.e., toward the legs. Preferably, the arms are integrally formed with the head. The arms are preferably curved and tapered along their length. In a preferred embodiment, the cross-section of each arm narrows from its base to its distal extremity.

Two resilient legs are fixed at their base and extend transverse to the plane of the head. Each leg has a foot at the distal end. Each foot includes a heel, located at the distal end of each leg, and a barb intermediate the heel and the leg base. The barb projects transverse to the lengthwise axis of the leg. The top or proximal (relative to the leg base) surface of the barb is preferably substantially perpendicular to the lengthwise axis of the leg. The bottom or distal (relative to the leg base) surface of the barb preferably tapers inwardly from the distal end of the top surface and terminates at an undercut between the barb and the heel. The heel preferably has a curved, bulbous shape and defines the end of the leg. The heel functions as a pilot during installation of the snap-in fastener. The undercut lies between the barb and the heel.

During installation, deformation of the inventive fastener occurs in the elastic zone of the material. The addition of the piloting heel makes the fastener self-guided. The fastener can be installed in either rectangular or circular holes in the panels to provide a permanent residual clamp load to the assembly. One main advantage of the present invention is its stable alignment characteristic provided by the addition of the piloting heel ahead of the barb that creates at a multi-point contact with the attached panel. If the hole in the bottom panel is rectangular, the fastener maintains four points of contact in a 2-dimensional plane section (four lines in actuality) between the feet 6 and the lower panel 2 as the fastener 11 is first positioned in the panel stack. If the hole in the bottom panel hole is round, the fastener maintains eight points of contact.

These and other advantages will follow from the foregoing explanation and the following drawings and description of the invention. The preferred embodiments of the invention will provide one of skill in the art with a full understanding of what has been invented. It will thereby be appreciated that the object of the invention to devise a micro-assembly snap-in fastener with various advantages over the prior art has been achieved.

### BRIEF DESCRIPTION OF THE DRAWINGS

FIG. 1a is a side elevation of a snap-in fastener in accordance with a preferred embodiment of the invention;

FIG. 1b is an enlarged section taken from FIG. 1a;

FIGS. 2, 3 and 4 are side elevations of the fastener of FIG. 1 during progressive installation steps in accordance with preferred embodiments of the invention;

FIG. 5 is a top right perspective of multiple fasteners prior to installation in two panels; and,

FIG. 6 is a top plan view of the multiple fasteners of FIG. 5 after installation in two panels.

### DESCRIPTION OF THE PREFERRED EMBODIMENT

Operation of the present snap-in fastener is based on elastic deformation (inward deflection and outward release or snapping) of its legs during installation, in combination with elastic deformation (loaded deflection) of the arms to ensure a correct and permanent clamp load on the assembly. Portions of the snap-in fastener's structure are based on the design theory of straight beams with variable cross sections that are elastically stressed. The snap-in fastener's structure generally includes two portions that control the function and operation of the device: an upper portion comprising mainly of the head and upper arms; and, a lower portion comprising the lower legs and active barb and heel combination.

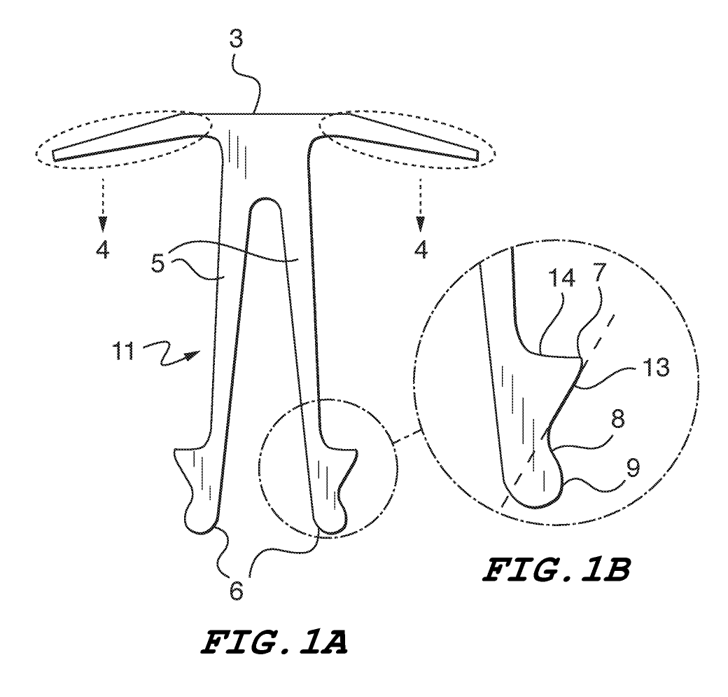

Referring to FIGS. 1a and 1b, a fastener in accordance with a preferred embodiment is designated generally by reference numeral 11 and has a head 3 with two arms 4 fixed to and extending laterally from opposed sides of the head 3. Each arm 4 is curved and tapered along its length. In a preferred embodiment shown in FIG. 3, each arm 4 has a concave curvature relative to the legs, and the cross-sectional area of each arm 4 narrows from its base to its distal extremity.

Two deformable and resilient legs 5 are fixed at their base to one side of the head intermediate the arms 4, and extend transverse to the plane of the head 3. The legs 5 each have a foot 6 at the distal (relative to the head) end. Preferably, each foot 6 is integrally formed at the distal end of the leg 5. Each foot 6 includes a pilot heel 9, located at the distal end of each leg 5, and a barb 7 intermediate the heel 9 and the leg base. The barb 7 projects generally transversely to the lengthwise axis of the leg 5. The top or proximal (relative to the leg base) surface 14 is preferably planar and substantially perpendicular to the axis of the leg 5. The bottom or distal (relative to the leg base) surface 13 preferably tapers inwardly from the distal end of the top surface 14 and terminates at an undercut 8 in between the barb 7 and the heel 9. The inward taper of the bottom surface 13 is shown by the dotted line in FIG. 1b. The distal end of the bottom surface 13 defines the upper boundary of the heel 9. The heel 9 preferably has a curved, bulbous shape and defines the end of the leg 5. The heel 9 functions as a pilot during installation of the snap-in fastener 11. The profile of a preferred embodiment of the foot 6 is shown in FIG. 1b. A theoretical extension along the bottom surface 13 is shown by the dotted line in FIG. 1b, which also defines the upper boundary of the heel 9. The distance between the barb 7 and heel 9 should be less than the thickness of the bottom panel 2 and the interior dimension (width or diameter depending on its shape) of the aperture in the bottom panel 2 should be slightly less than the maximum width from one heel 9 to the other heel 9 in the relaxed condition.

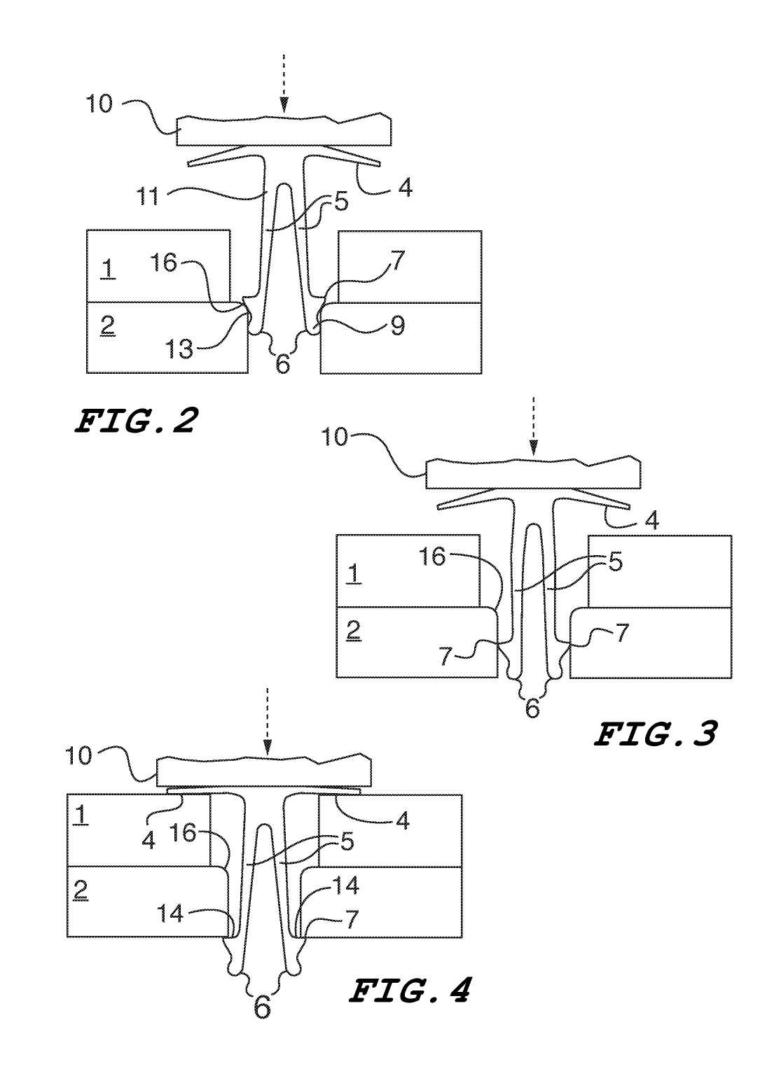

A method of installing the fastener and joining two panels in accordance with a preferred embodiment of the invention is demonstrated in FIGS. 2-4. The fastener 11 extends through aligned apertures in two (upper and lower) panels 1 and 2 that are stacked face-to-face. The lower panel 2 has a smaller hole than the upper panel 1, which forms a shoulder 16 on the lower panel 2 that is engageable by the fastener feet 6. Prior to installation, the legs 5 of the fastener 11 are relaxed, which causes the feet 6, including the heels 9, to widthwise extend a distance greater than the diameter (or width in the case of a rectangular hole) of the hole in the second panel 2.

FIG. 2 shows the fastener 11 at time zero in a generally-relaxed position ready for installation on a panel stack consisting of panels 1 and 2. The heels 9 of the fastener 11 are positioned in interference with the bottom panel 2 at the edges of the hole. Negligible stresses are induced in the legs 6 due to the positive engagement of the heel 9 and simultaneous contact with the bottom surface 13 of the barb 7. A punch 10 is shown initially impinging on the fastener head 3. After the fastener 11 is urged downwardly into the hole of the second panel 2, the heels 9 contact the side walls of the panel (below the shoulder 16) and are urged towards one another, causing the legs 5 to elastically deform. The bottom surface 13 of the barb 7 also contacts the side walls of the lower panel 2. In this position, the heels 9 are positioned below the shoulder 16. Preferably, the distance between the toe and heel contact points of each leg should be less than the width of the bottom panel, and the dimension of the aperture of the bottom panel should be less than the maximum free length distance between the outermost points on the heels 9.

At this position in the installation process, the fastener 11 maintains multiple points of contact with the second panel 2. Contact points are created between the heels 9 and the side wall of the hole in the second panel 2. Contact points are also created between the bottom surfaces 13 of the barb and the second panel 2. If the hole in the bottom panel is rectangular, the fastener maintains four points of contact in a 2-dimensional plane section (four lines in actuality) between the feet 6 and the lower panel 2 as the fastener 11 is first positioned in the panel stack. If the hole in the bottom panel hole is round, the fastener maintains eight points of contact. The contacts are made possible by the undercut 8 between the heel 9 and barb 7 of each leg 5. The multiple points of contact sufficiently prevent the fastener 11 from limping (leaning) to one side or the other during the initial positioning with the panels as well as during the first installation steps. Unlike prior art fasteners with one point or one line of contact that could define a center or an axis of rotation for the fastener 11, the multiple contact points provide a self-righting or uprighting feature to the fastener 11, which is not disclosed in the prior art. The fastener's construction, which enables the aforementioned multi-point contact, distinguishes this invention from the prior art.

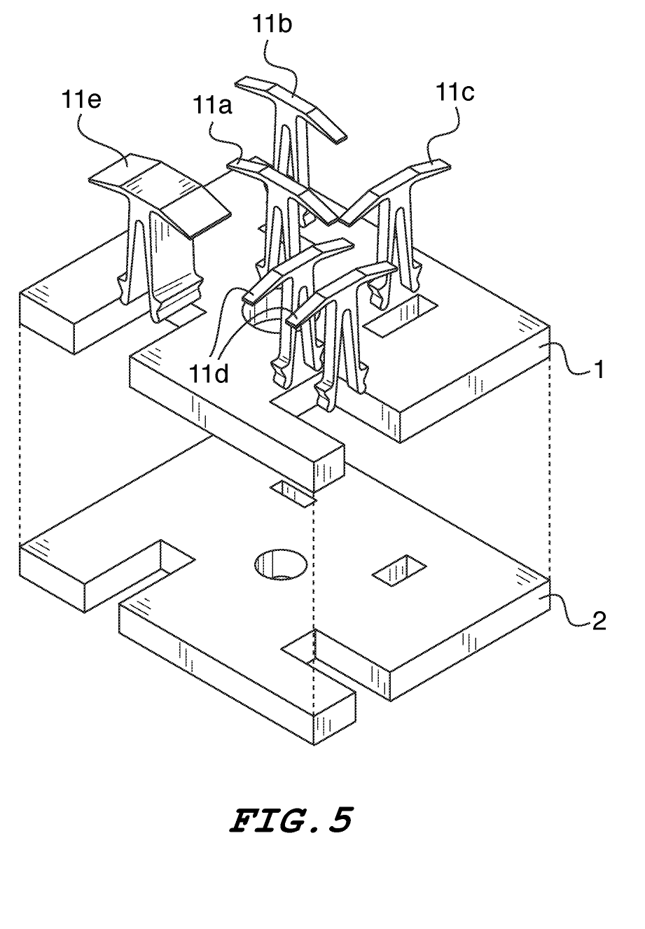

FIG. 3 shows the fastener 11 after the punch 10 has exerted a vertically-downward force on the head 3 and pushed the fastener 11 to the position shown therein, wherein the lower legs 6 flex inwardly and the feet 6 travel downwardly in the hole of the lower panel 2. In the position shown in FIG. 5, the lower legs 5 are elastically stressed inwardly. If the legs were not made from a resilient material, the feet 6 would likely damage the lower panel 2. The bending stress in each leg 5 is uniformly distributed along its length due to its tapered design in accordance with the variable cross section design theory of elastically stressed beams.

When approaching the final position shown in FIG. 4 but before the insertion distance equals the thickness of the lower panel 2, the head 3 comes into play and the arms 4 are deflected upwardly by the upper panel 1. As the fastener 11 is urged further downwardly, the arms 4 continue to flatten out and the barbs 7 exit the hole, which enables the legs 5 to snap back outwardly to a position close to their initial (relaxed) lateral position. In this position, the upper surface 14 of the toes 7 engage the underside of the lower panel 2.

When the final operational position presented in FIG. 4 is reached, the fastener must be resilient enough to allow the deformation of the upper arms 4 within the elastic zone of the material. Those arms 4 are not expected to go to their initial position (relative to the fastener's relaxed coordinates), and their stress should be retained to ensure a permanent elastic clamp load acting on the compressed panels 1, 2 at the end of the installation process. The upper arms 4 are also designed with a taper following the aforementioned theory to allow a uniform distribution of stresses in the active zones.

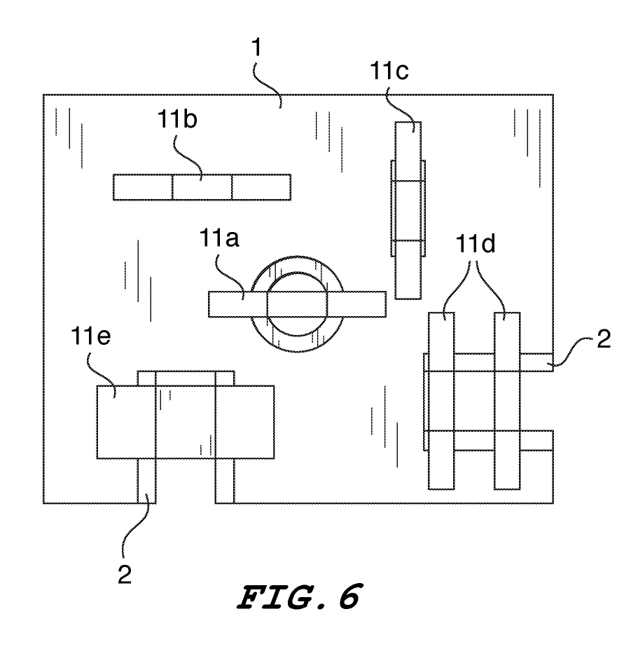

FIG. 5 shows the variety of ways in which the fastener 11 can be used. The middle fastener 11a is aligned for insertion into a round hole. The peripheral fasteners 11b, 11c, and 11d are aligned for insertion into rectangular holes arranged in different orientations (0, 30, 60, 90 degrees, etc.) either in unity 11b, 11c or combined with others 11d. FIG. 5 also shows a fastener 11e having a different thickness than the other fasteners 11a-d. FIG. 6 shows the panel assembly of FIG. 5 after the fasteners 11a-e have been installed.

1. A snap-in fastener, comprising:
a head having opposed, resilient arms fixed thereto and extending laterally to a distal free end;
two resilient legs fixed to the head and extending to a distal free end,
a foot fixed proximate the free end of each leg, each foot having a barb, a rounded heel at the distal free end, and an undercut between said heel and said barb.

2. The fastener recited in claim 1, wherein said barb has a planar top surface that extends substantially perpendicular to the lengthwise axis of the leg.

3. The fastener recited in claim 2, wherein said barb has a planar lower surface that extends inwardly from the upper surface toward the heel.

4. The fastener recited in claim 3, wherein the undercut is located at the intersection of the lower surface and the heel.

5. The fastener of claim 4, wherein each arm and each leg is tapered toward its distal end.

6. The fastener of claim 4, wherein said fastener is made from an elastomeric material.

7. The fastener of claim 1, wherein said arms are angled downwardly toward the legs.

8. The fastener of claim 1, wherein lateral cross-sections of the fastener at all points are rectangular.

9. An assembly, comprising;
a first panel having a first aperture;
a second panel in face-to-face abutment with the first panel and having a second aperture aligned with the first aperture;
a unitary fastener extending through said apertures, comprising:
a head having opposed, resilient arms fixed thereto and extending laterally to a distal free end;
two resilient legs fixed to the head and extending to a distal free end,
a foot fixed proximate the free end of each leg, each foot having a heel at the distal free end, a barb with a planar top surface that extends substantially perpendicular to the lengthwise axis of the leg and a planar lower surface that extends inwardly from the upper surface toward the heel, and an undercut between said heel and said barb;
wherein a residual clamp force is applied to the panels between the fastener head and the barb only by the resilience of the material of which the fastener is composed.

10. The assembly of claim 9, wherein the combined thickness of the panels is approximately 0.6 mm.

11. The assembly of claim 9, wherein at least one of the apertures is rectangular.

12. The assembly of claim 11, wherein both apertures are rectangular.

13. The assembly of claim 9, wherein at least one of the apertures in the panel is round.

14. The assembly of claim 13, wherein the aperture in both panels is round.

15. The assembly of claim 9 wherein the distance between the toe and the heel panel contact points is less than the width of the bottom panel.

16. The assembly of claim 15 wherein the engagement dimension of the aperture of the second panel is less than the free length distance between the outermost points on the heels.

17. The assembly of claim 9 wherein said second aperture is smaller than the first aperture such that a portion of a top side of the second panel at edges of the second panel adjacent the second aperture is revealed.

18. The assembly of claim 17 wherein there are four points of contact between the fastener legs and the second panel aperture as the fastener is installed.

19. The assembly of claim 18 wherein the points of contact are at the straight section and heel of the barb of each leg.

20. The assembly of claim 9 wherein the distance between the fastener leg toe and the heel is less than the width of the second panel.
